(19) United States
(12) Patent Application Publication
(10) Pub. No.: US 2012/0147545 A1
(43) Pub. Date: Jun. 14, 2012

(54) MOUNTING APPARATUS FOR DATA STORAGE DEVICES

(75) Inventors: HSIAO-YUAN NIU, Tu-Cheng (TW); KANG WU, Shenzhen City (CN); GUO-YI CHEN, Shenzhen City (CN); WEN-SEN HU, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/095,889

(22) Filed: Apr. 28, 2011

(30) Foreign Application Priority Data
Dec. 13, 2010 (CN) 201010584938.4

(51) Int. Cl. G06F 1/16

(52) U.S. Cl. 361/679.31

(57) ABSTRACT

A mounting apparatus that can be used to selectively mount a first type of data storage device or a second type of data storage device includes a bracket, and a circuit board mounted to the bracket. The bracket includes a rear board defining an opening. The circuit board includes a first side surface, and a second side surface opposite to the first side surface. A port protrudes from the second side surface, to extend through the opening to be exposed out of the bracket. A first connector or a second connector is selectively set on the first side surface of the circuit board, to be electrically connected to the port and the first type of data storage device or the second type of data storage device.

### BACKGROUND

1. Technical Field

The disclosure relates to a mounting apparatus for data storage devices.

2. Description of Related Art

Data storage devices are usually fixed in a bracket installed in a server or a computer. However, by conventional methodology, one kind of bracket is used to fix only one kind of data storage devices, such as a 3.5-inch hard disk bracket only for fixing 3.5-inch hard disk drives, a 2.5-inch hard disk bracket only for fixing 2.5-inch hard disk drives.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting apparatus and a first type of data storage device.

FIG. 2 is an assembled, isometric view of FIG. 1.

FIG. 3 is an exploded, isometric view of an exemplary embodiment of a mounting apparatus and two second type of data storage devices.

FIG. 4 is an assembled, isometric view of FIG. 3.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

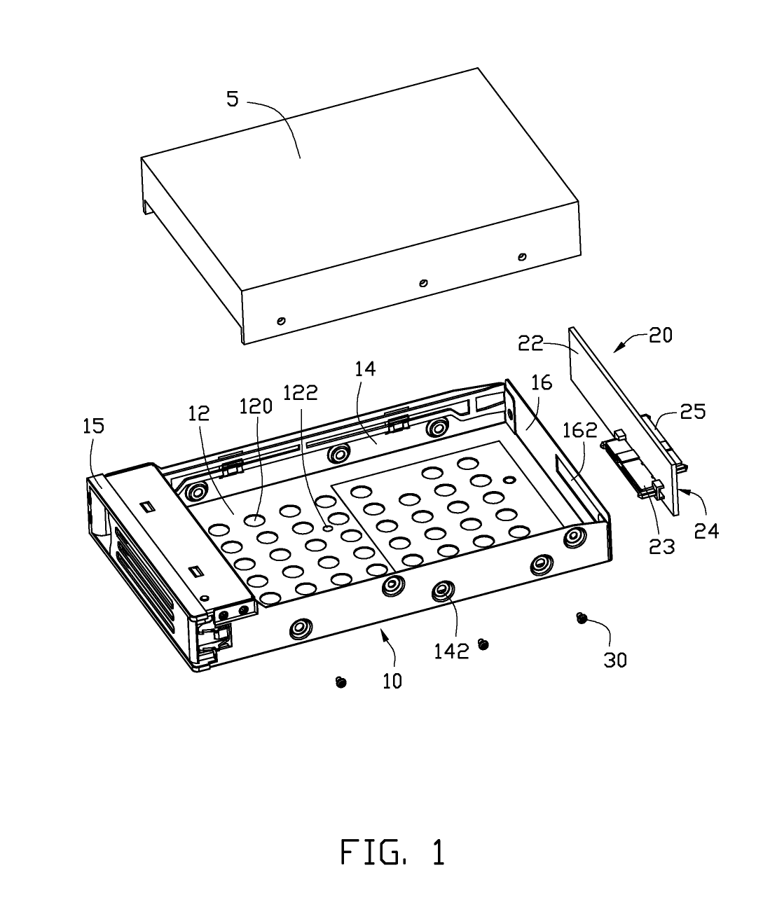

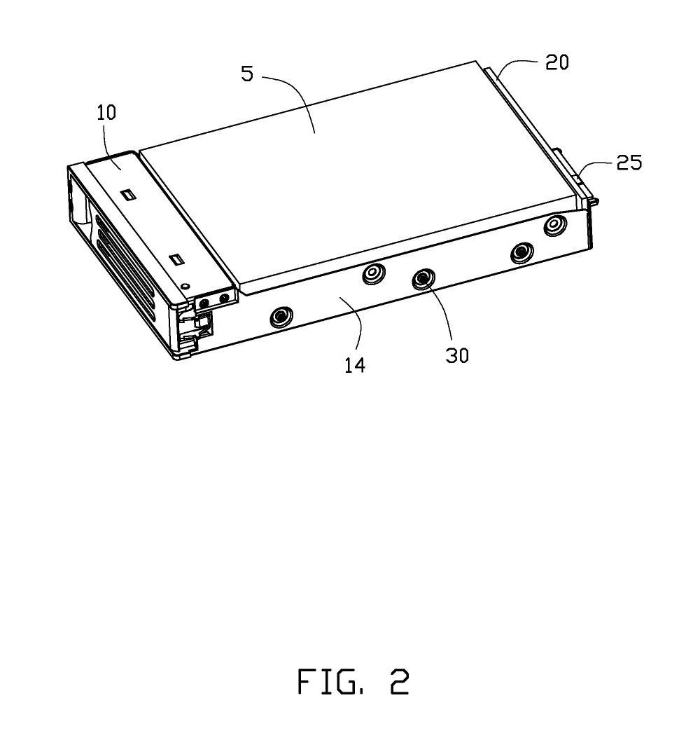

Referring to FIGS. 1 and 2, an exemplary embodiment of a mounting apparatus is capable of being used to selectively mount a first type of data storage device 5 (such as a 3.5-inch hard disk drive) or two second type of data storage devices 6 (such as two 2.5-inch hard disk drives). The mounting apparatus includes a bracket 10, a circuit board 20 mounting to the bracket 10, and a plurality of fastening members 30. In this embodiment, each fastening member 30 is a screw.

The bracket 10 includes a bottom plate 12, a front plate 15 and a rear plate 16 substantially perpendicularly extending up from opposite ends of the bottom plate 12, and two lateral plates 14 substantially perpendicularly extending up from opposite sides of the bottom plate 12. The lateral plates 14 are perpendicularly connected to corresponding ends of the front plate 15 and the rear plate 16. The bottom plate 12 defines a plurality of ventilation holes 120 for heat dissipation, and a plurality of fastening holes 122. Each lateral plate 14 defines a plurality of fastening holes 142. The rear plate 16 defines an opening 162.

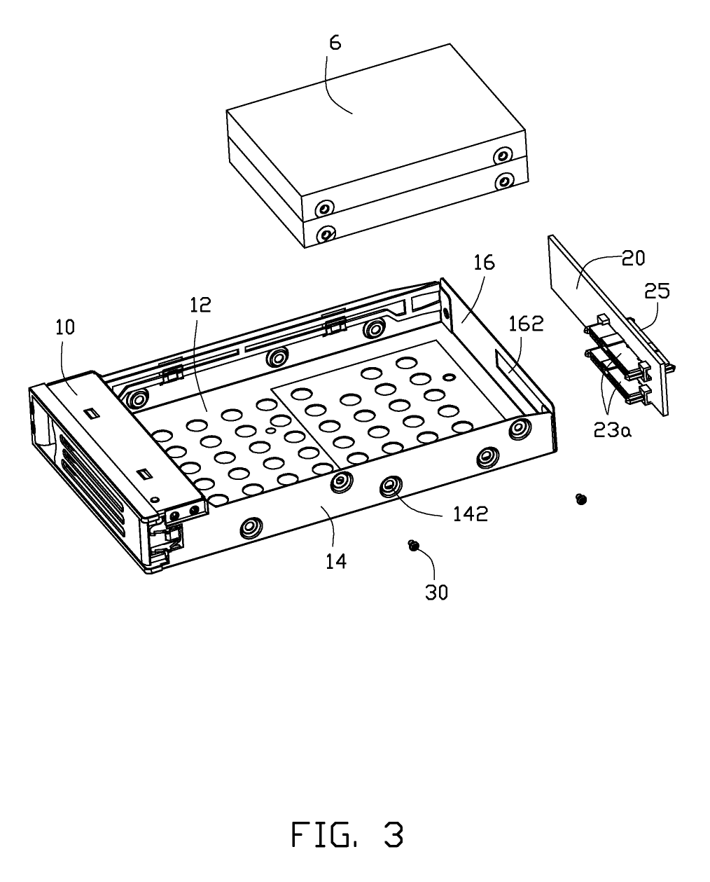

The circuit board 20 includes a first side surface 22 and a second side surface 24 opposite to the first side surface 22. A port 25 protrudes from the second side surface 24. A plurality of connectors is electrically and detachably set on the first side surface 22 to be electrically connected to the port 25. The number and the positions of the connectors on the first side surface 22 are adjustable, according to the type of data storage devices mounted in the bracket 10. In FIG. 1, when the first type of data storage device 5 is mounted in the bracket 10, a first connector 23 is electrically and detachably set on the first side surface 22 to be electrically connected to the data storage device 5 and the port 25. In FIG. 3, when the two second type of data storage devices 6 are mounted in the bracket 10, two second connectors 23a are electrically set on the first side surface 22 to be electrically connected to the data storage devices 6 and the port 25.

Referring to FIG. 2, in assembling the first type of data storage device 5, the first connector 23 is electrically set on the first side surface 22 of the circuit board 20. The circuit board 20 is mounted to an inner surface of the rear plate 16 of the bracket 10. The port 25 extends through the opening 162 to be exposed out of the bracket 10. The data storage device 5 is electrically connected to the first connector 23. The fastening members 30 extend through the fastening holes 142 to be locked in screw holes (not labeled) of the data storage device 5. Thus, the first type of data storage device 5 is mounted in the bracket 10. Obviously, the fastening members 30 can extend through the fastening holes 122 to be locked in screw holes (not labeled) of the data storage device 5 to mount the data storage device 5 in the bracket 10.

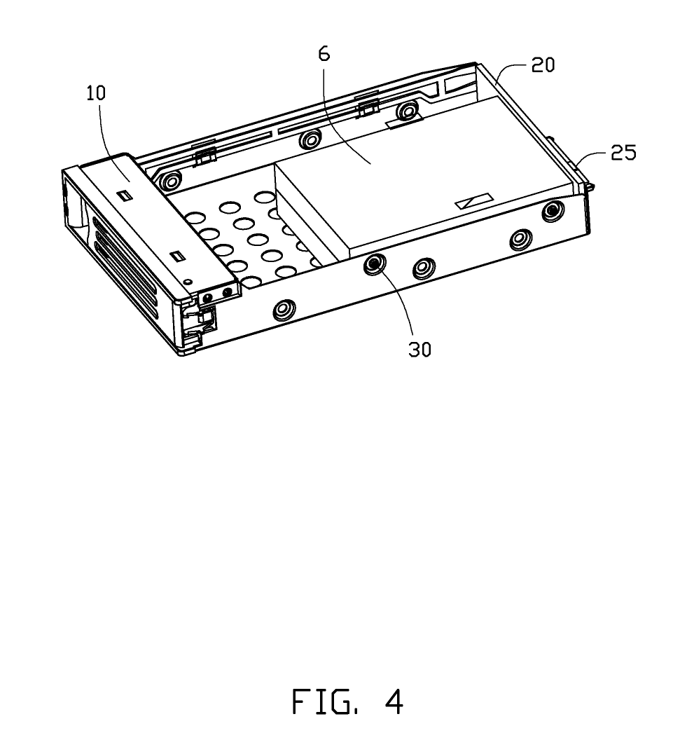

Referring to FIG. 4, in assembling the two second type of data storage devices 6, the two second connectors 23a are electrically set on the first side surface 22 of the circuit board 20, arranged up and down. The circuit board 20 is mounted to the inner surface of the rear plate 16 of the bracket 10. The port 25 extends through the opening 162 to be exposed out of the bracket 10. The data storage devices 6 are stacked up, and received in the bracket 10, to be electrically connected to the second connectors 23a. Some fastening members 30 extend through the fastening holes 122 of the bracket 10 to be locked in screw holes (not labeled) of the bottom of the lower data storage device 6. The other fastening members 30 extend through the fastening holes 142 of the bracket to be locked in screw holes (not labeled) of the upper data storage device 6. Thus, the two second type of data storage devices 6 are mounted in the bracket 10.

The bracket 10 can be used to mount either the first type of data storage device 5, or the second type of data storage devices 6, which improves the versatility of the bracket 10. Moreover, mounting the first or second type of data storage devices 5 and 6 can share a circuit board 20, to save costs.

In other embodiments, obviously, only one second type of data storage device 6 can be mounted in the bracket 10.

It is believed that the present embodiment and its advantages will be understood from the foregoing description, and it will be apparent that various changes may be made thereto without departing from the spirit and scope of the description or sacrificing all of their material advantages, the example hereinbefore described merely being exemplary embodiment.

What is claimed is:

1. A mounting apparatus to selectively mount a first type of data storage device or a second type of data storage device, the mounting apparatus comprising:
a bracket comprising a rear board defining an opening; and
a circuit board mounted to an inner surface of the rear board, wherein the circuit board comprises a first side surface, and a second side surface opposite to the first side surface, a port protrudes from the second side surface, to extend through the opening to be exposed out of the bracket, and a first connector or a second connector is selectively set on the first side surface, to be electrically connected to the port and the first type of data storage device or the second type of data storage device.

2. The mounting apparatus of claim 1, wherein the bracket further comprises a bottom plate and two lateral plates substantially perpendicularly extending up from opposite sides of the bottom plate, the rear plate substantially extends up from a rear end of the bottom plate.

3. The mounting apparatus of claim 2, wherein the bottom plate defines a plurality of venation holes for heat dissipation.

4. The mounting apparatus of claim 2, wherein the lateral plates each define a plurality of fastening holes through which a plurality of fastening members extend to be fixed to opposite sides of the data storage device.

5. The mounting apparatus of claim 2, wherein the bottom plate defines a plurality of fastening holes through which a plurality of fastening members extend to be fixed to a bottom of the data storage device.
